(19) United States
(12) Patent Application Publication
(10) Pub. No.: US 2014/0272852 A1
(43) Pub. Date: Sep. 18, 2014

(54) METHOD FOR TREATING NEUROLOGICAL IMPAIRMENT

(71) Applicant: Aryanish Patel, Mumbai (IN)

(72) Inventor: Aryanish Patel, Mumbai (IN)

(21) Appl. No.: 13/944,601

(22) Filed: Jul. 17, 2013

Related U.S. Application Data
(60) Provisional application No. 61/791,714, filed on Mar. 15, 2013.

(51) Int. Cl. G09B 19/00

(52) U.S. Cl. CPC G09B 19/003
USPC 434/247

(57) ABSTRACT

Method having activities for treating persons having neurological impairment and kit for performing the method.

### CROSS REFERENCE TO RELATED APPLICATIONS

This application claims priority under 35 U.S.C. §119 from U.S. Provisional Patent Application Ser. No. 61/791,714, entitled METHOD FOR TREATING NEUROLOGICAL IMPAIRMENT, filed on Mar. 15, 2013, which is incorporated by reference herein in its entirety and for all purposes.

### FIELD OF INVENTION

The present invention relates to a method for treating neurological impairment comprising a set of activities for improving vision including hand-eye coordination, reading, writing and speech.

### BACKGROUND

The human brain's efficiency and performance depend on the seamless transition of neurowork signals from one area of the brain to another. People having neurological impairment thereby affecting their neurowork signals often feel immense difficulty in performing everyday tasks. Research has shown that lack of good hand-eye coordination is responsible for such impeded functionality which also impact their other daily activities. Such impairment is also commonly known as dyslexic or dyscalculia. However, it must be understood that such weak coordination is not a result of diminished mental faculties or vision impairments but only due to an inability to match one's fine motor skills with the faculty of vision. In a recent study by Dr. Neal Alpiner, Md. of William Beaumont Hospital, Royal Oak, “functional MRI study of the Effects OF IM on Auditory-Motor processing Networks” suggests that such impediments can be corrected through playful exercises that emphasize on the use of these abilities and in the process, correct and improve them.

Further in relation to impairment of vision it has also been observed that some dyslexic people have a hard time reading a clock from the face of a conventional watch. The numbers on the dial that represent time in a circular order are hard to grasp. Since dyslexics find it difficult to read time in the regular clockwise order, all conventional watches and clocks are quite useless for them and reading time becomes a time consuming task in itself.

Learning through playing is effortless as opposed to conventional ways of learning, for example classroom lectures, that become stressful remedial work for dyslexics. In fact, students and children look forward to such playful sessions that involve interaction and team participation. Such exercises directly affect and boost the neural pathways (connections that join one part of brain with another). Research has confirmed that severed or poorly formed connections are restored and this in turn positively changes the functioning of the brain.

New research has argued that dyslexia may result from impairment of a different linguistic system than previously thought. Speech perception engages at least two linguistic systems: the phonetic system, which extracts discrete sound units from acoustic input, and the phonological system, which combines these units to form individual words

Previously, researchers generally believed that dyslexia was caused by phonological impairment, but results from the current study, led by Iris Berent of Northeastern University in Boston, suggest that the phonetic system may actually be the cause.

“Our findings confirm that dyslexia indeed compromises the language system, but the locus of the deficit is in the phonetic, not the phonological system, as had been previously assumed,” says Berent.

In the study, Hebrew-speaking college students had difficulty discriminating between similar speech sounds, but had no problem tracking abstract phonological patterns, even for novel words, suggesting that the phonological system is intact but the phonetic system is compromised.

“Our research demonstrates that a closer analysis of the language system can radically alter our understanding of the disorder, and ultimately, its treatment,” concluded Berent. The study has been published in the open access journal PLOS ONE″ Berent I, Vaknin-Nusbaum V, Balaban E, Galaburda AM (2012) Dyslexia Impairs Speech Recognition but Can Spare Phonological Competence. PLoS ONE 7(9): e44875. doi:10.1371/journal.pone.0044875”

Further no two dyslexics are same and different people may have different kind of impairment like vision or speech or learning etc. Thus we need different approaches and variety of methods to treat them as the cause is always not known or cannot be assessed easily.

It is an object of present invention to improve hand eye coordination of neurological impairments like dyslexics or dyscalculia.

It is another object of present invention to improve reading and writing of dyslexics through games.

It is another object of present invention to build confidence in dyslexics by improving their speech through games preferably in a software application.

It is another object of present invention to rectify and assist dyslexics having mirror image vision, through games and preferably in a software application.

### SUMMARY OF INVENTION

As explained above no two dyslexics are same and different people may have different kind of impairment like vision or speech or learning etc. Thus we need different approaches and variety of methods to treat them as the cause is always not known or cannot be assessed easily.

The present invention teaches a method having a number of activities for treating children or person having neurological impairment like dyslexia or dyscalculia, and more specifically having problem in relation to their vision including hand-eye coordination, speech and while writing.

In one instance, the activity addresses the problem of the hand-eye coordination which comprises plurality of activity with plurality of dice or small stone. The activity can be carried out even by only one player.

In a second instance, the activity addresses the problem of hand-eye coordination which comprises plurality activity with plurality of dice or small stone, a chart of 200 everyday words having mirror writing problem and at least two players.

In a third instance, the activity addresses the problem of hand-eye coordination which comprises plurality of paper sheet for writing and plurality of writing object.

Another aspect of treating dyslexics is modified reversed clock which provides better accessibility to certain dyslexics who have difficulty reading time from a conventional clock.

These simple games are based on some very intricate principles that govern the human brain. A continuous practice results in better performance at home, work and school. The individual is able to realize one's optimum performance and face the many challenges dyslexics face with effortless ease. An improved hand-eye coordination results in a better alignment of the mind and body. It fosters confidence, growth and curiosity in an individual that was earlier hampered by the compromised maneuverability due to poor hand-eye coordination.

### BRIEF DESCRIPTION OF THE DRAWINGS

FIG. 1 is a schematic block diagram of the one embodiment of the kit of the present teachings;

FIG. 1a is a graphical representation of one embodiment of the kit of the present teachings and of its use;

FIGS. 2-8 are graphical representations of steps in different embodiments of the method of these teachings; and

FIGS. 9a and 9b are graphical representations of the one embodiment of the present teachings.

### DETAILED DESCRIPTION OF THE INVENTION

A “geometrical solid object,” as used herein refers to an object such as a cube, a dice or a stone, which has a predetermined volume. It should be noted that the geometrical solid object can be hollow and/or soft.

A “scoring component,” as used herein, includes an electronic scoring component, a mechanical scoring component.

A “display device,” as used herein includes an electronic display device.

The present invention is to treat dyslexics by improving their hand-eye coordination.

In one or more embodiments, the present teachings include a kit for activities to treat dyslexics by improving their hand-eye coordination. In one or more embodiments, the kit of the present teachings includes a number of solid geometrical objects, the solid geometrical objects being of dimensions configured for being held in a hand of one subject; wherein all of the solid geometrical objects can be held together in the hand of said one subject, and a scoring device. In another instance, the kit also includes a display device, the display device configured for displaying a list of words; words from said list of words selected from words exhibiting a mirror writing problem. In one instance, at least one of the solid geometrical objects is a soft solid geometrical object.

FIG. 1 is a schematic block diagram of one embodiment of the kit of the present teachings. Referring to FIG. 1, in the embodiment shown therein, the kit includes geometrical objects 10, blocks in the embodiment shown, a scoring device 20 and a display device 30. FIG. 1a is a graphical representation of one embodiment of the kit of the present teachings and of its use. Referring to FIG. 1a, in the embodiment shown therein, the kit includes 5 blocks and a mechanical scoring device.

In one method of these teachings, a simple game is introduced for dyslexics to play.

In one ore embodiments, the method of these teachings includes (a) holding, the one hand of a subject, a first number of solid geometrical objects, (b) placing, at a surface located lower than an elbow position of the subject, a second number of solid geometrical objects, the second number being one less than the first number, one solid geometrical object remaining in the hand of the subject, (c) tossing the one solid geometrical object in the air, (d) retrieving, with the hand of the subject, a third number of the second number of solid geometrical objects, (e) catching the one solid geometrical object while holding the third number of the second number of solid geometrical objects, and (f) repeating (c) through (e) while holding retrieved solid geometrical objects from the second number of solid geometrical objects until all of the second number of solid geometrical objects has been retrieved.

One aspect of present invention where a game requires hand-eye coordination, one embodiment of the method of the present invention comprises 5 substantially identical cubes, a game box that houses the 5 cubes and an instruction manual, which describes the rules of the game, and a scoring device. A player starts the game by holding all 5 cubes in one hand. Next, 4 cubes are dropped on the ground table while 1 cube is retained. The player then tosses the cube in hand in air and while the cube is in air, the player must pick up another cube from the ground/table and also catch the tossed cube after picking up a cube. Player continues picking up each cube (“stone”) in this manner till all four cubes are finished. With every toss, the player must pick another cube from the ground/table while catching the tossed cube and also retaining the earlier picked cube(s). With each progression, the number of cubes in hand increases by 1. So in second stage of this activity player repeats previous acts by picking up 2 cubes from ground each time. In third stage of this activity player tosses one cube in air and ticks three cubes at first time and one cube second time from ground while one is still in air and catch it after picking the cube from ground. Next stage of the game is when the player is, tossing 1 cube in air and picking up the all four cubes from the ground/table. In final move of game player tosses all five cubes up in air and tries to catch all five cubes. After successfully completing a round the player can add one point to the score board. In case, a round is not completed and the player is unable to catch the tossed cube or pick up a cube from the table/ground, the player must start the round from the very beginning. The game can also be played by two players where each player takes turns and the player who reaches the highest score in 10 rounds wins.

FIG. 2 is a graphical representation of one step in the embodiment of the method of these teachings disclosed hereinabove.

Another embodiment of the method of these teachings is disclosed herein below.

Another aspect of present invention is an activity involving two players, a cube of a soft material, a word list of 200 everyday words (e.g. ‘to’, ‘if’, ‘the’, ‘for’, etc.) having a mirror writing problem to be corrected. The cube is thrown by a player towards the other player so that the other can catch the cube. While the cube is mid-air, the player throwing the cube must spell a word that starts with a letter that poses difficulty due to mirror writing problem. The complete word must be spelt aloud while the cube is travelling to the other player. The other player must return the cube in a similar way and each game comprises seven such rounds.

While the cube is thrown by an individual and the words are spelt, the other individual gets time to visualize the information and grasp it quickly. In some cases, the dyslexic mind can literally ‘see’ the information that is being spoken. Since the game also involves precision of direction and timing, both these faculties are also addressed and improved through this game.

This simple game also encourages communication between two people and improves the hand-eye co-ordination.

Another aspect of present invention is a game comprises of a specially designed writing note book that has 30 lines in every page and is divided into several sections of 21 pages. A child makes a continuous cursive writing of ‘s’ for 1 section i.e. 21 pages consisting of 30 lines.

Through these simple exercises in a game format, we are providing the necessary stimulus to a dyslexic mind to function in a manner that is closest to the regular thinking of a non-dyslexic. These games boost confidence and allow an individual to align him/her with the stress free, natural state of effortless learning. One can overcome the difficulties in writing and reading and everyday problem that are an outcome of these two are also reduced. So this simple game helps an individual in three areas—reading, writing and confidence issues.

Learning through playing is effortless as opposed to conventional ways of learning, for example classroom lectures, that become stressful remedial work for dyslexics, in fact, students and children look forward to such playful sessions that involve interaction and team participation. Such exercises directly affect and boost the neural pathways (connections that join one part of brain with another). Research has confirmed that severed or poorly formed connections are restored and this in turn positively changes the functioning of the brain.

FIG. 3 shows partial contents of another embodiment of the kit of the present teachings. Referring to FIG. 3, in the embodiment shown therein, the solid geometrical objects are substantially spherical beads and the display device displays one letter form a set of pairs of mirror letters. FIG. 6 shows an embodiment in which the display device this place one or more graphology exercises.

In another embodiment of the method of these teachings, the method includes holding, the one hand of a subject, one solid substantially spherical object, such as a substantially spherical bead, and copying, in some instances repeatedly, using the other hand of the subject, a pattern or letter displayed in a display device while holding the solid spherical object. The pattern or letter can be one of the pairs of mirror letters as shown in FIG. 3 or one of the graphology exercises shown in FIG. 6. FIGS. 4-5 and 7 show different steps in the above described embodiment, while being performed. FIG. 8 shows a graphology exercise sheet that can be used in performing one of the steps in the above described embodiment.

Another aspect of present invention is a modified reversed clock which provides better accessibility to certain dyslexics who have difficulty reading time from a conventional clock. FIGS. 9a and 9b show instances of the modified reversed clock of these teachings.

The design comprises an analogue clock with a large dial, three clock arms of varying lengths to read hours, minutes and seconds and digits that are swapped horizontally with their adjacent numbers. The modified clock has digits swapped in the following manner:

1-11

2-10

3-9

4-8

5-7

The modified clock provides better accessibility to certain dyslexics who have difficulty reading time from an unmodified clock. Changing the order in which the numbers appear solves the problem of a clockwise order and the watch can be read easily by dyslexics who have a mirror writing problem because the position of numbers is horizontally mirrored. This also solves, to some extent, the problem of ‘not being on time’ for dyslexics. Since dyslexics have difficulty in reading time, they often assume what the correct time would be and end up being either too early or too late for appointments and meetings.

For the purposes of describing and defining the present teachings, it is noted that the term “substantially” is utilized herein to represent the inherent degree of uncertainty that may be attributed to any quantitative comparison, value, measurement, or other representation.

The term “substantially” is also utilized herein to represent the degree by which a quantitative representation may vary from a stated reference without resulting in a change in the basic function of the subject matter at issue.

Although these teachings has been described with respect to various embodiments, it should be realized these teachings is also capable of a wide variety of further and other embodiments within the spirit and scope of the claims.

What is claimed is:

1. A method for improving and-eye coordination in a neurologically impaired subject, the method comprising:
(a) holding, the one hand of a subject, a first number of solid geometrical objects;
(b) placing, at a surface located lower than an elbow position of the subject, a second number of solid geometrical objects, the second number being one less than the first number, one solid geometrical object remaining in the hand of the subject;
(c) tossing the one solid geometrical object in the air;
(d) retrieving, with the hand of the subject, a third number of the second number of solid geometrical objects;
(e) catching the one solid geometrical object while holding the third number of the second number of solid geometrical objects; and
(f) repeating (c) through (e) while holding retrieved solid geometrical objects from the second number of solid geometrical objects until all of the second number of solid geometrical objects has been retrieved.

2. The method of claim 1 wherein the third number is one (1).

3. The method of claim 1 wherein the third number is one (1) for (c)-(f); and wherein the method further comprises:
setting the third number to two (2) after (c)-(f);
(g) placing, at a surface located lower than an elbow position of the subject, the second number of solid geometrical objects, the second number being one less than the first number, one solid geometrical object remaining in the hand of the subject;
(h) tossing the one solid geometrical object in the air;
(i) retrieving, with the hand of the subject, the third number of the second number of solid geometrical objects;
(j) catching the one solid geometrical object while holding the third number of the second number of solid geometrical objects; and
(k) repeating (h) through (j) while holding retrieved solid geometrical objects from the second number of solid geometrical objects until all of the second number of solid geometrical objects has been retrieved.

4. The method of claim 3 further compsing:
setting the third number to three (3) after h)-k);
(l)) placing, at a surface located lower than an elbow position of the subject, the second number of solid geometrical objects, the second number being one less than the first number, one solid geometrical object remaining in the hand of the subject;
(m) tossing the one solid geometrical object in the air;
(n) retrieving, with the hand of the subject, the third number of the second number of solid geometrical objects;
(o) catching the one solid geometrical object while holding the third number of the second number of solid geometrical objects; and
(p) repeating (m) through (o) while holding retrieved solid geometrical objects from the second number of solid geometrical objects until all of the second number of solid geometrical objects has been retrieved or a number less than the third number remains;
if a number less than the third number remains, setting the setting the third number to the number less than the third number and repeating (m) through (p).

5. The method of claim 4 further comprising, if steps have been successfully completed, adding one point to a score in a scoring device.

6. The method of claim 5 wherein, if the steps have not been successfully completed, the subject restarts the method from a beginning.

7. The method of claim 4 wherein the first number is five (5).

8. The method of claim 6 wherein another subject repeats the method from a beginning; wherein the subject and said another subject repeats the method taking turns; and wherein one of the subject or said another is declared winner after obtaining a higher score in a predetermined number of repetitions.

9. A method for improving and-eye coordination in a neurologically impaired subjects, the method comprising:
(a) throwing a soft solid geometrical object from one of two subjects to another one of two subjects;
(b) before the soft solid geometrical object is caught by said another one, said one spells aloud a word from a list of words displayed on a display device; words from said list of words selected from words exhibiting a mirror writing problem;
(c) throwing, after receiving the soft solid geometrical object from said one, throwing the soft solid geometrical object from said another one of two subjects to said one of two subjects; and
(d) before the soft solid geometrical object is caught by said r one, said another one spells aloud another word from the list of words displayed on the display device.

10. The method of claim 9 further comprising repeating steps (a)-(d) a predetermined number of times.

11. A kit for improving and-eye coordination in a neurologically impaired subjects comprising:
a number of solid geometrical objects, said solid geometrical objects being of dimensions configured for being held in a hand of one subject; wherein all of said number of solid geometrical objects can be held together in the hand of said one subject; and
a scoring device.

12. The kit of claim 11 further comprising a display device, the display device configured for displaying a list of words; words from said list of words selected from words exhibiting a mirror writing problem.

13. The kit of claim 11 wherein at least one of said number of solid geometrical objects is a soft solid geometrical object.

14. A clock comprising a dial having figures marking numbers which are a mirror image with respect to the 12-6 axis of a conventional clock dial.
